(19) United States
(12) Patent Application Publication
(10) Pub. No.: US 2014/0162741 A1
(43) Pub. Date: Jun. 12, 2014

(54) Entertainment Fantasy League

(71) Applicant: Comcast Cable Communications, LLC, Philadelphia, PA (US)

(72) Inventors: Eileen Diskin, Wallingford, PA (US); Robin Dagostino, Wayne, PA (US); Kenny White, San Francisco, CA (US); Elizabeth Lusby, San Francisco, CA (US)

(21) Appl. No.: 13/708,424

(22) Filed: Dec. 7, 2012

(51) Int. Cl. A63F 13/00; A63F 13/12

(52) U.S. Cl. CPC A63F 13/005; A63F 13/12
USPC 463/1; 463/25; 463/42

(57) ABSTRACT

An entertainment fantasy league may allow participants to select celebrities, actors, movies, television programs, songs, movie production studios and other entertainment elements to be on their team, and scoring may be done by granting points for performance of the team members, in conjunction with the participant's own media consumption habits. Performance may be measured in terms of award nominations and wins, popularity, box office returns, etc., and the participant's consumption habits may be based on whether the participant viewed an entire program without skipping commercials, or if the participant purchased tickets to see a movie.

### BACKGROUND

Tracking celebrity and frame is a hobby for many, and today's media offerings include a wide variety of sources from which the latest gossip may be had. Competition among newspapers and magazines for readers' attention, and among content providers and users, is fierce, and there remains an ever-present need for effective and entertaining ways to engage fans and maintain their attention.

### SUMMARY

The features described in the summary appearing below are merely example features, and the selection and/or omission of features from this summary is not an admission regarding the criticality of those features to the claims. Ultimately, it is the claims that define the scope of this patent.

Features described herein relate to a system and method for implementing an entertainment fantasy competition, such as a fantasy league. In some embodiments, a computing device can maintain and manage the league data by, for example, storing information identifying the various league participants' (owners') teams including entertainers such as celebrities, and granting or deducting points based on the entertainers' performance and on other factors such as the owners' own video consumption habits. The performance may include being nominated for, or winning, an award, and different point values may be awarded for the nomination and the win. The performance may also include coverage in the media, such as the celebrity appearing in stories in print publications.

In some embodiments, the computing device may conduct a draft, allowing owners to select team assets (e.g., players, such as entertainers and media items) to be included on their respective team, and wherein during the draft, the computing device may make celebrity recommendations based on the owners' previous video consumption habits. The computing device may also send targeted advertising information to an owner based on the selections made by the owner.

In some embodiments, the teams may include other team assets or players, such as video programs or media items, and the performance of the video programs may be based on their popularity. In some embodiments, bonus points may be awarded for combined performances of an entertainer and a video program. In some embodiments, the teams may include other assets, such as movie production entities, audio programs, and the like.

In some embodiments, points may be granted to a team based on the owner's data use, such as video consumption habits, such as whether the owner skipped any commercials contained in the consumed video, or if the participant viewed all of the commercials.

These and other aspects will be described in connection with the drawings in the Detailed Description portion of this disclosure.

### BRIEF DESCRIPTION OF THE DRAWINGS

FIG. 1 illustrates an example system on which features described herein may be implemented.

FIG. 2 illustrates an example computing device that may be used to implement any of the computing devices and servers described herein.

FIGS. 3a-c illustrate an example method for an entertainment fantasy league.

FIG. 4 illustrates an example schedule for an entertainment fantasy league.

### DETAILED DESCRIPTION

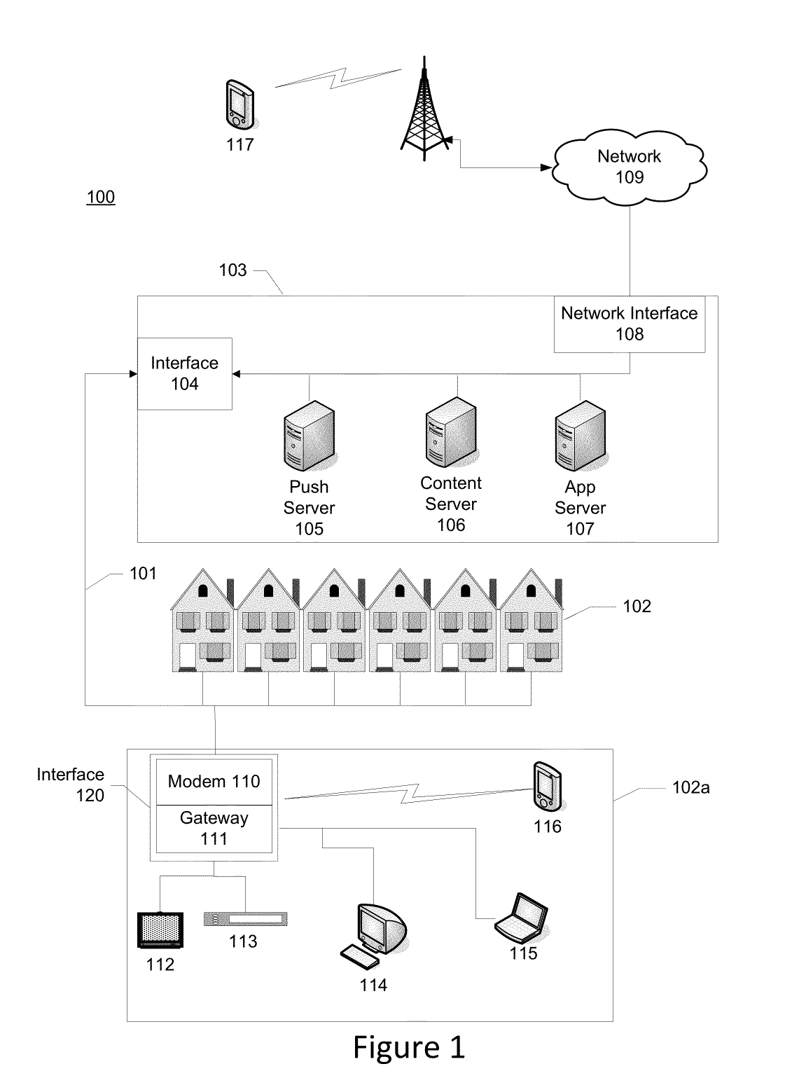

FIG. 1 illustrates an example information distribution network 100 on which many of the various features described herein may be implemented. Network 100 may be any type of information distribution network, such as satellite, telephone, cellular, wireless, etc. One example may be an optical fiber network, a coaxial cable network or a hybrid fiber/coax (HFC) distribution network. Such networks 100 use a series of interconnected communication links 101 (e.g., coaxial cables, optical fibers, wireless, etc.) to connect multiple premises 102 (e.g., businesses, homes, consumer dwellings, etc.) to a local office 103 (e.g., a headend, central office, a processing facility, etc.). The local office 103 may transmit downstream information signals onto the links 101, and each premises 102 may have a receiver used to receive and process those signals. The geographic location of the local office 103 can vary, and the local office 103 may be proximate to a user's neighborhood in some embodiments, while in other embodiments, the local office 103 may be remotely located at a centralized location. The various servers may be located anywhere, and their location need not be relevant to a user (e.g., the servers may be in the “cloud”).

There may be one link 101 originating from the local office 103, and it may be split a number of times to distribute the signal to various premises 102 in the vicinity (which may be many miles) of the local office 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other lines, or wireless communication paths.

The local office 103 may include an interface 104, such as a termination system (TS) or a cable modem termination system (CMTS) in an example of an HFC-type network, which may be a computing device configured to manage communications between devices on the network of links 101 and backend devices such as servers 105-7 (to be discussed further below). In the example of an HFC-type network, the MTS may be as specified in a standard, such as the Data Over Cable Service Interface Specification (DOCSIS) standard, published by Cable Television Laboratories, Inc. (a.k.a. CableLabs), or it may be a similar or modified device instead. The MTS may be configured to place data on one or more downstream frequencies to be received by modems at the various premises 102, and to receive upstream communications from those modems on one or more upstream frequencies. The local office 103 may also include one or more network interfaces 108, which can permit the local office 103 to communicate with various other external networks 109. These networks 109 may include, for example, Internet Protocol (IP) networks Internet devices, telephone networks, cellular telephone networks, fiber optic networks, local wireless networks (e.g., LTE, WiMAX, etc.), satellite networks, and any other desired network, and the interface 108 may include the corresponding circuitry needed to communicate on the network 109, and to other devices on the network such as a cellular telephone network and its corresponding cell phones. Collectively, these networks 109 may be referred to herein as “the cloud” or “cloud architecture.”

As noted above, the local office 103 may include a variety of servers that may be configured to perform various functions. For example, the local office 103 may include a back office server 105. The back office server 105 may generate push notifications related to functions such as billing, reporting, and subscriber management 400 to deliver data and/or commands to the various premises 102 in the network (or more specifically, to the devices in the premises 102 that are configured to detect such notifications). The local office 103 may also include a content server. The content server 106 may be one or more computing devices that are configured to provide content to users, who may be, for example, in the homes. In some embodiments, the content server 106 may include software to validate (or initiate the validation of) user identities and entitlements, locate and retrieve (or initiate the locating and retrieval of) requested content, encrypt the content, and initiate delivery (e.g., streaming, transmitting via a series of content fragments) of the content to the requesting user and/or device. Other server computing devices may be present as well. Also, the various servers and elements are depicted in a local office 103, but they need not be co-located in a common premises, and instead may have some or all elements remotely in the network 109.

The local office 103 may also communicate with one or more application servers 107 maintained in the cloud 109. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. Another application server may be responsible for monitoring user viewing habits and collecting that information for use in selecting advertisements. Another application server may be responsible for formatting and inserting advertisements in a video stream and/or content item being transmitted to the premises 102.

An example premises 102a may include an interface 120, which may include a modem 110 (or another receiver and/or transmitter device suitable for a particular network), which may include transmitters and receivers used to communicate on the links 101 and with the local office 103. The modem 110 may be, for example, a coaxial cable modem (for coaxial cable lines 101), a fiber interface node (for fiber optic links 101), or any other desired modem device. The modem 110 may be connected to, or be a part of, a gateway interface device 111. The gateway interface device 111 may be a computing device that communicates with the modem 110 to allow one or more other devices in the home to communicate with the local office 103 and other devices beyond the local office. The gateway 111 may be a set-top box (STB), digital video recorder (DVR), computer server, or any other desired computing device. The gateway 111 may also include (not shown) local network interfaces to provide communication signals to other devices in the home (e.g., user devices), such as televisions 112, additional STBs 113, personal computers 114, laptop computers 115, wireless devices 116 (wireless laptops and netbooks, mobile phones, mobile televisions, tablet computers, PDA, etc.), and any other desired devices. Examples of the local network interfaces may include Multimedia Over Coax Alliance (MoCA) interfaces, Ethernet interfaces, universal serial bus (USB) interfaces, wireless interfaces (e.g., IEEE 802.11), 3G, WiMax, LTE, Bluetooth interfaces, and others. In some embodiments, the system uses ZigBee and Z-Wave compliant devices.

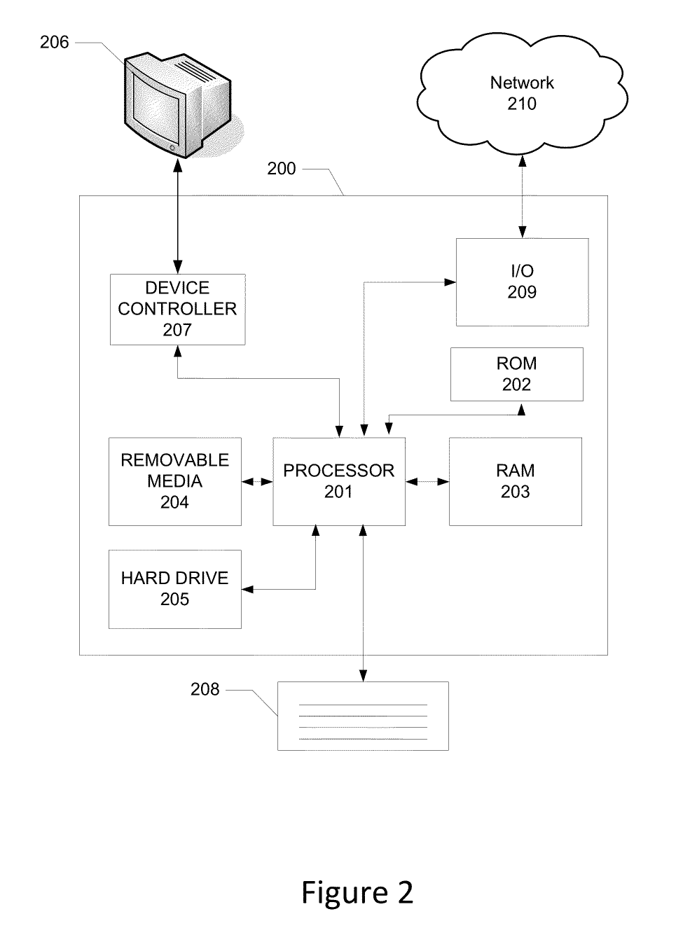

FIG. 2 illustrates general hardware elements that can be used to implement any of the various computing devices discussed herein. The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired electronic storage medium. Instructions may also be stored in an attached (or internal) storage 205 (e.g., hard drive, flash, etc.). The computing device 200 may include one or more output devices, such as a display 206 (or an external television), and may include one or more output device controllers 207, such as a video processor. There may also be one or more user input devices 208, such as a remote control, keyboard, mouse, touch screen, microphone, camera, etc. The computing device 200 may also include one or more network interfaces, such as input/output circuits 209 (such as a network card) to communicate with an external network 210. The network interface may be a wired interface, wireless interface, or a combination of the two. In some embodiments, the interface 209 may include a modem (e.g., a cable modem), and network 210 may include the communication lines 101 discussed above, the external network 109, an in-home network, a provider's wireless, coaxial, fiber, or hybrid fiber/coaxial distribution system (e.g., a DOCSIS network), or any other desired network.

The FIG. 2 example is an example hardware configuration. Modifications may be made to add, remove, combine, divide, etc. components as desired. Additionally, the components illustrated may be implemented using basic computing devices and components, and the same components (e.g., processor 201, storage 202, user interface 205, etc.) may be used to implement any of the other computing devices and components described herein. For example, the various components herein may be implemented using computing devices having components such as a processor executing computer-executable instructions stored on a computer-readable medium, as illustrated in FIG. 2.

One or more aspects of the disclosure may be embodied in computer-usable data and/or computer-executable instructions, such as in one or more program modules, executed by one or more computers or other devices to perform any of the functions described herein. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

As discussed above, the local office of an information distribution or access network may transmit information downstream to various user devices. The transmitted information may include content (e.g., audio, video, Internet data, etc.) for consumption (e.g., playback, viewing, listening, display, storage, etc.) by a user via user equipment, such as a gateway interface device (e.g., gateway interface device 111 of FIG. 1) and/or other computing device (e.g., televisions 112, additional STBs 113, personal computers 114, laptop computers 115, wireless devices 117 of FIG. 1). To assist in providing the content to a user, a content provider may implement in their distribution network an information distribution management system that includes one or more information distribution management devices (e.g., one or more servers and/or other devices) configured to perform various processes related to managing the providing of content to the user equipment (e.g., user device). The features herein include techniques, systems, apparatus, and methods for mapping trick modes of operation in connection with the playback of media content wherein the trick modes of operation are mapped to alternate advertising or other media content. The features will be described hereinbelow primarily in connection with an embodiment in a television service network, such as a cable television network. However, it should be understood that this is merely exemplary. The features may be implemented in connection with any form of media content, including audio content, video content, and multimedia content, and in connection with any number of delivery mechanisms for such content, including television networks, media delivered via the Internet or another information network, media stored on any digital medium, including, but not limited to, DVDs, CDs, solid-state memory, and hard disk drives such as found in computers and DVRs.

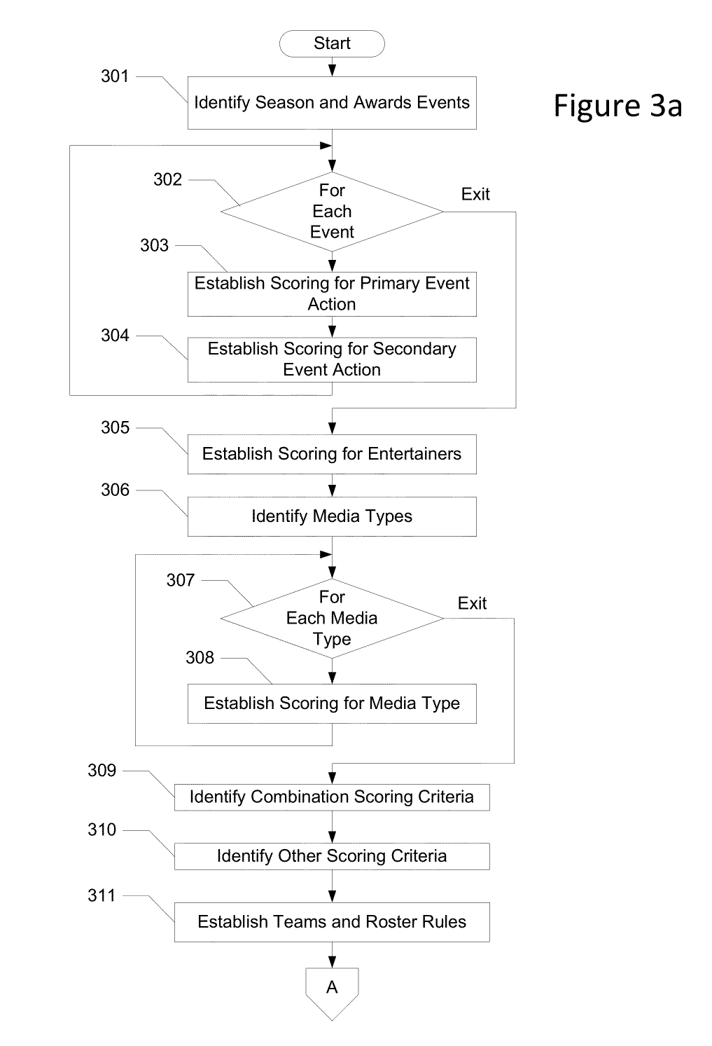

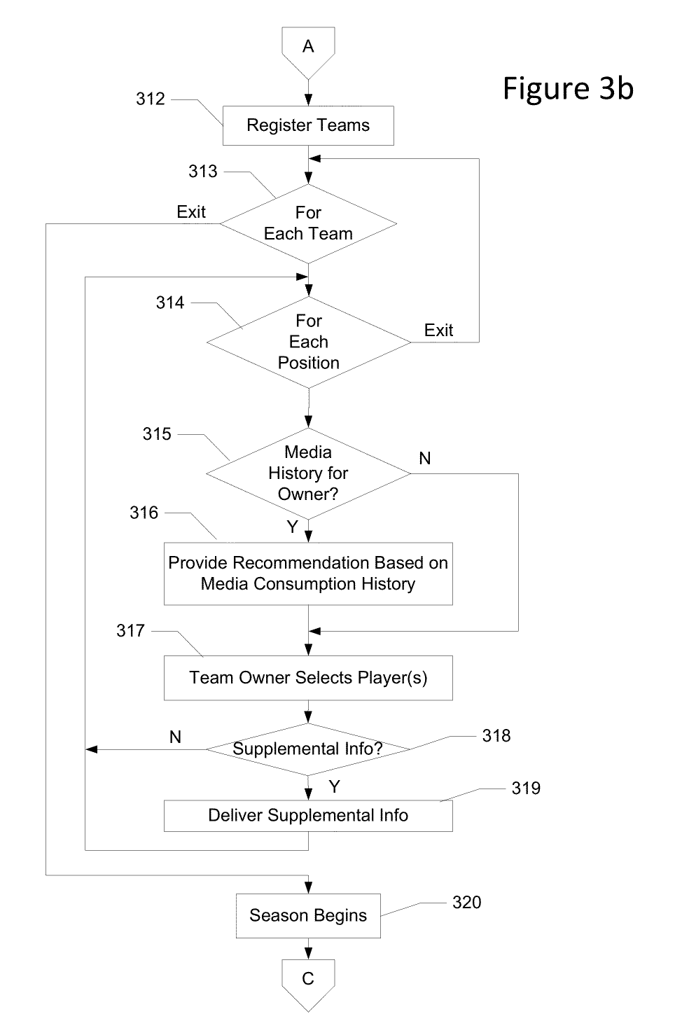

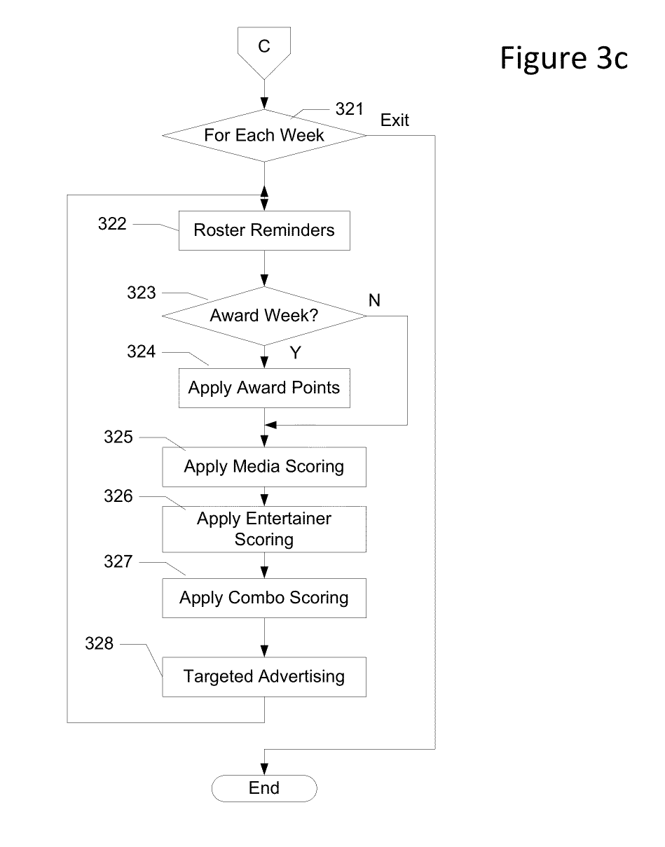

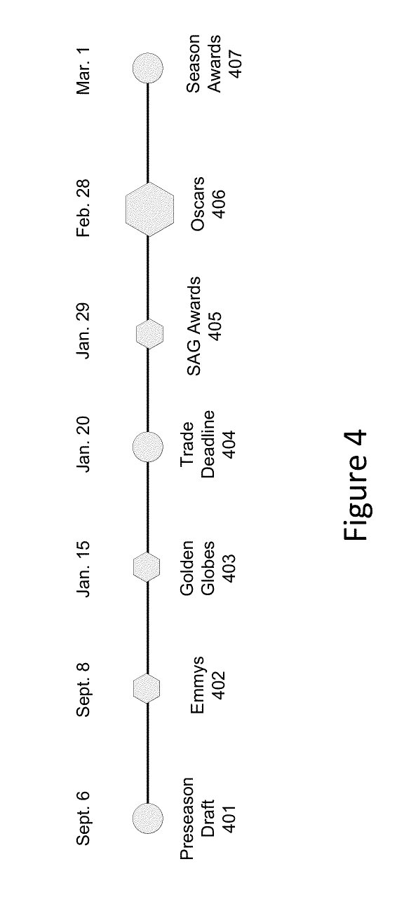

FIGS. 3a-c illustrate an example method of implementing an entertainment fantasy competitions, such as a fantasy league. The various method steps may be performed by a computing device, such as an application server 107, or on a user's personal computer 115 or smartphone 116. To begin, in step 301, the league's manager, a computing device, or a combination thereof may identify the season duration and relevant awards events that are to be included in the fantasy season. This identification can be done, for example, by receiving user inputs designating the start/end dates of the season, and the relevant events such as awards and entertainment-related events that are scheduled to occur in the season. FIG. 4 illustrates an example timeline, showing example events in the season, such as the initial draft 401, awards for the EMMYS™ 402 and GOLDEN GLOBES™ 403, a team trade deadline 404 for the fantasy league, additional awards for the SCREEN ACTORS GUILD™ 405 and OSCARS™ 406, and a final date 407 for conclusion of the season and granting awards to the league's winners (and losers). Although several awards are illustrated, events may include other awards, and other activities such as theatrical releases, actor appearances, scheduled programs, and other activities relating to entertainment content and beyond.

In step 302, the computing device may begin a loop to handle each event identified in step 301. For each event, the computing device may establish a scoring algorithm such as a scoring algorithm for a primary event action, such as nomination of an award 303, and for a secondary event action, such as winning, the award 304. The scoring algorithm may simply identify a point value based on, for example, user input, to be awarded to the player (e.g., celebrity actor, movie, television show, etc.) for being nominated to receive the award. For example, a nomination for the Best Actor OSCAR™ may be deemed to be worth 5 points for the participant whose team includes the nominated actor. Other kinds of events may have their own scoring algorithms, with different primary and secondary (and more if desired) event actions. For example, a content event such as an episode of a reality television program, may be provided with a scoring algorithm that awards points for advancing in the program's reality competition (e.g., point values for each stage in an elimination competition), for appearing, hosting, or being listed in the program, or for otherwise participating in or being associated with the event.

In some embodiments, the scoring algorithm may be weighted. For example, some awards may be considered more prestigious than others, and the point scale for those more prestigious awards may be higher than those of lesser awards. For example, awards such as the OSCARS™, EMMYS™, and GOLDEN GLOBES™ may yield +5 points for nominations and +10 points for wins, while other awards such as the CRITIC'S CHOICE™, SCREEN ACTORS GUILD™ may receive +3 points for nomination and +5 for win. Some awards may grant negative points. For example, some awards such as the RAZZIES™ are intended to be granted for poor or embarrassing performances, and those may result in negative points being awarded. One example of an award point breakdown may resemble the following:

| Award | Points |
|---|---|
| OSCAR ™ nomination | 5 |
| OSCAR ™ win | 10 |
| GOLDEN GLOBE ™ nomination | 5 |
| GOLDEN GLOBE ™ win | 10 |
| EMMY ™ nomination | 5 |
| EMMY ™ win | 10 |
| RAZZIE ™ nomination | −5 |
| RAZZIE ™ win | −10 |
| CRITIC'S CHOICE ™ nomination | 3 |
| CRITIC'S CHOICE ™ win | 5 |

The process may return to step 303 to process the next event, and when all events have been processed, the computing device may proceed to step 305, and establish a scoring algorithm for individuals, who are typically entertainment celebrities or other parties in the public domain. The scoring algorithm for individuals may include a wide variety of point values to be awarded for different types of performance involving the person. For example, points may be awarded based on an entertainer's fashionability rating, as measured by fashion critics. The types of performance can include, for example, a celebrity appearing in trade publications, news reports, Internet articles, etc. Of course, these performances involving the entertainer need not be physically undertaken by the entertainer (e.g., a celebrity might not have done anything at all to appear in an Internet article about him/her). Performances can also include rating and popularity data for media content in which the entertainer appears. For example, an actor may receive a point for hosting an event, such as an awards show, or for making an appearance on a talk show, television program, etc. As another example, if an actor's movie has an opening weekend that exceeds a predetermined box office amount (e.g., an $80 million opening weekend, or 10 million tickets sold), then the owner whose team includes the actor may receive points for that performance. There may be multiple thresholds for different point values, such as 1 point for an opening weekend that exceeds $20 million, an additional 3 points for an opening weekend that exceeds $80 million, and an additional 5 points for an opening weekend that exceeds $100 million. Other ratings metrics may be used as well. For example, movies are often given ratings by movie reviewers. The scoring algorithm for the celebrity may identify different point values for different ratings that a celebrity's movie attains (e.g., an average 4-star rating on a given reviewing Internet site may be worth 5 points, while an average 3-star rating may be worth 3 points).

In step 306, a plurality of different media types may be identified for the fantasy league. Media types may include any desired genre or classification of media. For example, theatrical release movies, pay-television movies, video on demand movies, rental digital versatile disk (DVD) content, over-the-air or paid television programming, comic books, video games, Internet videos, blogs, general commenters, music and radio, etc. may all be considered types of media that can be scored in the entertainment fantasy league.

In step 307, the device may begin a loop for each identified media type, and in step 308, a scoring algorithm may be established for each media type. A media type's scoring algorithm may include scoring for performance by items in the media type. For example, for a video on demand (VOD) media type, the scoring algorithm may define a plurality of point values to be awarded for different total numbers of purchases, streaming or viewing requests, or dollar receipts. A video may receive 1 point for every thousand VOD buys that purchase the video. Points may be awarded based on overall viewership, such as that measured by the NIELSEN™ ratings or other ratings. A theatrical release movie may be granted points based on the number of box office tickets sold. Paid television programming may receive points based on how highly viewed they are, or how highly rated they are by media reviewers and critics. The scoring algorithm may grant points for popularity in the same way as described above for actors and celebrities (e.g., a movie being ranked highly on an Internet site). The scoring may also take into account the owner's consumption of the media. For example, an owner who purchases a movie ticket for a movie on his/her team may be granted points for the purchase, or an owner may be awarded points for viewing a program on his/her team without skipping any commercials, or the owner may receive a smaller point value if the participant skips commercials. The process may return to step 307 for each media type, and when all media types are treated, the process may proceed to step 309.

In step 309, which may optionally be performed (as with any of the scoring algorithms), the computing device may identify one or more combination scoring algorithms. For example, a combination scoring algorithm may grant bonus points to an owner if his/her team includes two entities that achieved a predefined joint performance. For example, one combination may grant bonus points to an owner if two actors on his/her team appear together in an interview. The combination can cross entity types, and include an actor and media type. For example, one combination can grant bonus points if an actor is in a predetermined number of articles while the actor's television series achieves a predetermined ratings value, and both the actor and the television series are on the same participant's team.

In step 310, the computing device may identify one or more other types of scoring algorithms or criteria. For example, social critic review network (e.g., Internet) sites may allow users to vote on the popularity of anything in the entertainment universe (e.g., actors, movies, etc.), generating so-called “buzz” for the item, and the popularity ranking can be awarded points. For example, some network sites allow visitors to vote on popular (or unpopular) actors, or indicate that they like the particular actor (e.g., a “Like” tag on an actor's profile), and the sites may maintain a ranking of the votes, or a listing of the top ten most popular actors. Social media services may also track the number of times that an actor (or other media item) is mentioned in social messages and posts, or the number of followers or fans that the actor has. The rating scoring metric may grant points for appearing on such lists, with points varying based on site type and credibility or popularity, and/or on the ranking (e.g., 5 points for being on top of the list, one point for fifth place, etc.). Similarly, popularity measurement tools such as E-SCORE™ may be used to identify a popularity rating for an entity, and the entertainment fantasy league scoring algorithm can grant points based on this popularity rating. In some embodiments, these other scoring algorithms can be included in the celebrity/media type/combination scoring algorithms discussed above.

With the scoring system complete, the method may proceed to step 311, and define other elements of the league's season, such as how many teams are to compete, and what the roster minimums are for each team may be established. The roster minimum may identify minimum numbers of team members and/or member types. For example, the device may indicate that a team is to have 15 members, comprised of 5 actors, 5 pieces of media such as movies, shows, songs, Internet pages, etc. and 5 awards.

In step 312, the teams may be registered. Registration may involve identifying the teams in the league, team owners who are playing, and identifying team names, contact information such as email addresses. In some embodiments, a league may have six (6) teams, or may be limited to having between 2 and 6 teams, and team owners may be given the option of inviting their friends to join.

In step 313, the device may begin a looping process for each team to fill out the team roster with players (who may be personalities, entertainers, movies, television series, or any other entertainment item). The looping process is shown as completing a loop for one team before moving on to the next, but that is simply for ease of explanation. The actual looping process may perform steps in alternative orders, such as allowing each team to have one pick before making a second pick. The player draft may be conducted in a looping order (e.g., same picking order each round), a snake order (e.g., reverse picking order each round), bidding process (e.g., teams have limited number of points for purchasing rights to players, and bid on players), etc. Indeed, all of the process steps described herein may be rearranged and modified or skipped, and other steps may be added, as desired.

In step 314, the method may involve a loop to fill each required position in the team, as specified in step 311. The league may specify minimum and maximum types of players for each team. For example, the league may specify a ten-player roster with the following minimums:

1 movie actor
1 movie actress
1 TV actor
1 TV actress
1 Reality TV actor
1 Reality TV actress

### 1 Theatrical Movie

### 1 TV Series

2 Wildcard (any type of player)

In some embodiments, the available players are simply chosen in a sequential order, where in each round of the draft, each team is given one opportunity to select a player from the available pool of players. In some embodiments, the available players may be assigned a point value, and each team may have a limited pool of points that the team can spend on its players. Accordingly, certain more popular players may be given high point values by a system administrator based on the player's expected and/or historical performance, and teams may need to spend points from their allotment to obtain the players. In such embodiments, players may be duplicated across teams, such that any team that wishes to spend their points to obtain a particular player may do so, and the same player may appear on all of their teams. In other embodiments, players may be limited to a single team, and the teams may place bids in an auction-style format to secure the players for their teams. Such “salary cap” style distributions of players to teams may help to promote equality among teams when there is a strong disparity in the amount of points that the top players are expected to generate, and if players are not allowed to appear in more than one team.

Each week of the season, team owners may be required to designate a subset of their team as active, e.g., starters, for the week, where a team's score may be based only on points earned by that week's starters. The required lineup may also have minimums at different positions or player types (e.g., a minimum number of movie actors, TV actresses, Theatrical movies, etc.). Again, this loop is shown in the depicted order for ease of explanation, and in implementation can be done in any order (e.g., teams may fill their rosters in any desired order in the draft, filling positions in different orders).

In step 315, it may be determined whether a positional recommendation should be made for the given participant whose team is being drafted. The positional recommendation may be made, for example, based on whether media consumption history information is available for the given participant. Media consumption history may be any information identifying the content consumption history of the participant. For example, this history may identify the VOD or online, etc. purchase history of a given user, his/her network (e.g., Internet) browsing history, his/her theater going habits, his/her most listened to songs or most viewed programs, etc. Any available personal information, if allowed by the owner, may be used by the device to identify possible positional recommendations.

In step 315, if media history information is available, then in step 316 the device may consult the history information to provide a recommendation for the current position to the participant. For example, the owner may be filling an actor position, and the device may determine that the owner has viewed a large number (exceeding a predetermined minimum, such as 10) of movies starring Harrison Ford. In step 316, the device may offer a recommendation to the owner to select Harrison Ford as an actor for his/her team.

Then, in step 317, the team owner participant may select an entity for the position on his/her team. For example, the participant may elect to add Harrison Ford to his/her entertainment fantasy league.

In step 318, the device may determine whether an advertisement or additional information exists for the selected player, and if the participant meets predetermined requirements for receiving the additional information. For example, the device may store information indicating that an owner who selects a particular celebrity may receive a targeted advertisement based on the selected celebrity, or a free video download of a preview for the celebrity's upcoming movie, or may receive an advertisement for the celebrity's movie as part of an Internet browser. The additional information may be conditioned, for example, on the owner having a video on demand account, or some other requirement for accessing the content. If supplemental info is to be delivered, then in step 319, that info may be delivered. The delivery may be an email with a code for a video download, adding a video to a user's list of available video on demand content, delivering an advertisement to the user's Internet browser, delivering a print ad through the mail, or any other desired delivery mechanism. The loops 314 and 313 may then continue until each team has filled the required positions on his/her team.

In step 320, the entertainment fantasy season may begin. In step 321, the device may being a loop for each scoring period in the season. The scoring period may be any desired amount of time (e.g., an entire season, or intervals in a year) for which performance is measured and points are awarded for performance by the various entities in the teams. For example, the scoring period may be a week, and each week the device may tabulate points to be awarded for performance by team members in that week. In step 322, the computing device may send roster reminders to the various owners. The roster reminder may identify events that are scheduled to occur in the given week, such as award nomination announcements and presentation, theatrical release of a film or DVD or online release of a video, periodic reports on style or media (e.g., monthly fashion evaluation), or other events that week that can affect scoring. Owners may then have until a set time (e.g., midnight on Friday) to set their active roster of starters for the week. An active roster of starters may be a selected subset of the owner's overall team, where the starters are the ones designated for scoring that week (e.g., other non-starter members of the team do not accrue points for the team that week).

In step 323, it may be determined whether the current week is an award week. An award week may be a week in which an award (e.g., the EMMYS™) announces nominations or winners.

If it is an award week, then in step 324, points may be tabulated and granted for the awards whose week it is. For example, if the current week had the EMMY™ nominations, then the device could determine which actors and programs received nominations, and can consult the award's scoring algorithm to determine what point values are to be awarded to teams having the nominated actors and/or programs.

In step 325, media type scoring may be applied, according to the media type scoring algorithms defined above. For example, if a theatrical release movie type algorithm calls for awarding points based on box office performance, then in the current week the computing device may obtain the box office results for the various theatrical release movies that are members of a team in the league, and the computing device may tabulate and grant the point values to the teams based on the box office performance. Similarly, in steps 326 and 327, the device may tabulate and award points for celebrities and combinations, based on their respective scoring algorithms.

In step 328, the team owner may be identified for receipt of targeted advertising based on his/her team's performance. For example, a league management computing device may store information identifying one or more advertisements corresponding to the various players in the league. An actor may have several advertisements for his/her upcoming film. A television series may have several advertisements for its upcoming episode. In this step, the players on the owner's team may be analyzed to determine which ones have scored sufficient points to warrant targeted advertising. For example, the computing device may be configured to deliver targeted advertising to an owner when that owner's player scores 10 points in a given week. Alternatively, the computing device may automatically identify the highest scoring player on an owner's team, and select an advertisement for that player to deliver to the owner. The advertisements themselves can take a variety of forms. For example, some ads may be 30-second video advertisements, inserted in a video stream viewed by the user. Other ads may be network or Internet advertisements, displayed on the owner's computer as the owner is browsing the network.

The processing of targeted advertising may also affect the scoring. For example, the computing device may track the consumption habits of the owner (e.g., whether the owner watched or skipped certain advertisements), and adjust the scoring granted to the owner. An owner who watches more advertisements for a player on his/her team may be granted additional points, while an owner who skipped advertisements for a player may be penalized with a scoring reduction.

When all scoring periods have been tabulated, the process may then complete with the determination of the league's season winners/rankings. At the end of a season, participants having the winning team (or teams) may be granted various prizes.

The discussion above addresses an example of an entertainment fantasy league, which can be used to help garner interest among users for consuming entertainment-related content. Some users, however, might not wish to commit to a full league in this manner. To keep those users engaged at the level they want, some embodiments of the system described herein may include options for smaller-scale games. For example, individual games may be established for each of the awards and/or events shown in the FIG. 4 season. One individual game may allow players to simply guess as to who will win a particular OSCAR™ or EMMY™, or who will be mentioned the most for their attire at an awards show. Other games may allow players to guess which programs will be selected for another season, or which ones will be canceled. Programs that offer competitions, such as talent shows and challenge shows, may allow users to guess winners of the shows, and may grant points based on the number of correct picks and/or how early the correct pick was made (e.g., a correct pick made one month in advance of the award may be worth more than a correct pick made the week of the award). Winning these individual games may result in receiving prizes, and may also result in earning points that can be added to a team's point total for the entertainment season.

One type of individual game may involve posing a series of questions at predetermined intervals, and requiring competitors to accumulate streaks of consecutive correct answers. For example, a system administrator may release three questions every day, and track users' answers. Users who maintain the longest streak of days with at least one correct answer may be awarded a prize at the end of the competition.

Another game may be an elimination-type game. In such a game, each player may be asked to select a program that they believe will be among the top five-rated programs for the week, and players whose selected programs are not among the top five that week are eliminated from the competition. In such a game, users may be prohibited from selecting the same program or series more than once.

In some embodiments, an application server 107 may maintain an Internet site containing the scores for the various teams. The site may rank the teams according to score, show their head-to-head matchups for the week, and allow team owners to view and manage their teams. The site may also allow team owners to post results to one or more social media services, announcing their successes and/or participation in the entertainment fantasy league.

The various features described herein are merely examples. Additional features and modifications can be used or added. For example, team participants may be allowed to trade players, and a trade deadline may be set in the schedule to indicate when trades must be completed. The features may be rearranged, combined, modified and even omitted as desired for any particular embodiment, and the scope of this patent should be determined by the claims that follow.

1. A method, comprising:
storing information identifying an entertainment fantasy league owner's team comprising of entertainers; and
granting credit to the participant based on the entertainers' performance and on the owner's video consumption behavior.

2. The method of claim 1, the granting further comprising evaluating an entertainer's performance by identifying an award for which the entertainer was nominated, and granting a first point value to the owner based on the entertainer's award nomination.

3. The method of claim 1, the granting further comprising evaluating an entertainer's performance by identifying an award won by the entertainer, and granting a first point value to the owner based on the entertainer's award win.

4. The method of claim 1, the granting further comprising evaluating an entertainer's performance by identifying an amount of coverage given to the entertainer in entertainment media, the media including entertainment print publications.

5. The method of claim 1, further comprising conducting a draft in which the owner selects celebrities to be on the owner's team, and wherein during the draft, the method comprises sending the owner a celebrity recommendation based on the owner's previous video consumption behavior.

6. The method of claim 1, further comprising conducting a draft in which the owner selects entertainers to be on the owner's team, and wherein during the draft, the method comprises sending the owner a media advertisement based on an entertainer selection made by the owner.

7. The method of claim 1, wherein the owner's team further comprises one or more video programs or audio programs.

8. The method of claim 7, further comprising granting points to the owner based on a measured popularity of the one or more video programs or audio programs on the owner's team.

9. The method of claim 7, further comprising granting bonus points to the owner based on performance of a celebrity and a program that are both on the owner's team.

10. The method of claim 1, wherein the owner's team further comprises a movie production entity.

11. The method of claim 1, wherein granting the owner points based on the owner's video consumption behavior is further based on whether the owner skipped any commercials contained in a consumed video.

12. The method of claim 11, further comprising granting a point bonus to the owner if the owner consumed a video that is on the owner's team, and if during the consumption the owner viewed all of the commercials contained in the consumed video without fast forwarding or skipping any of them.

13. The method of claim 1, further comprising the computing device sending periodic roster reminders to owners in the entertainment fantasy league, wherein the roster reminders include information identifying whether an award is scheduled to be presented.

14. A computer-readable medium, storing instructions that, when executed by a processor, cause the following to occur:
storing information identifying an entertainment fantasy league participant's team comprising of celebrities; and
granting points to the participant based on the celebrities' performance and on the participants' video consumption behavior.

15. The computer-readable medium of claim 14, further storing instructions that, when executed by the processor, cause the following to occur:
evaluating a celebrity's performance by identifying an award for which the celebrity was nominated, and granting a first point value to the participant based on the celebrity's award nomination.

16. The computer-readable medium of claim 14, further storing instructions that, when executed by the processor, cause the following to occur:
conducting a draft in which the participant selects celebrities to be on the participant's team, and wherein during the draft, the method comprises sending the participant a celebrity recommendation based on the participant's previous video consumption behavior.

17. The computer-readable medium of claim 14, further storing instructions that, when executed by the processor, cause the following to occur: conducting a draft in which the participant selects celebrities to be on the participant's team, and wherein during the draft, the method comprises sending the participant a media advertisement based on a celebrity selection made by the participant.

18. The computer-readable medium of claim 14, wherein granting the participant points based on the participant's video consumption behavior is further based on whether the participant skipped any commercials contained in a consumed video.

19. A method, comprising:
maintaining an entertainment fantasy league in which league teams include actors and media types as players;
granting points to teams based at least in part on whether a team owner skipped commercials during consumption of a piece of media.

20. The method of claim 19, further comprising:
granting a team points based on whether the team owner purchased tickets to see a theatrical movie.
